(19) United States
(12) Patent Application Publication
(10) Pub. No.: US 2026/0274615 A1
(43) Pub. Date: Sep. 17, 2026

(54) FREE-FALL PROTECTION ASSEMBLY FOR ELEVATOR SYSTEM AND METHOD OF OPERATION THEREOF

(71) Applicant: HCL Technologies Limited, New Delhi (IN)

(72) Inventors: Shant Kumar, Bengaluru (IN); Vinod Kumar Srinivasa, Bangalore (IN)

(21) Appl. No.: 19/330,862

(22) Filed: Sep. 17, 2025

(30) Foreign Application Priority Data
Mar. 13, 2025 (IN) 202511022853

(51) Int. Cl. B66B 5/16

(52) U.S. Cl. CPC B66B 5/16

(57) ABSTRACT

This disclosure relates to a free-fall prevention assembly, elevator assembly, and method of operation. The free-fall prevention assembly includes a magnetic element positioned underneath the elevator car that is configured to generate a first magnetic field. The free-fall prevention assembly further includes a copper bucket positioned in an elevator pit configured to generate a second magnetic field in response to an eddy current induced therein. The eddy current is induced in response to a passage of the first magnetic field through the copper bucket as the magnetic element of the elevator car moves relative to the copper bucket in the elevator pit. The second magnetic field repels the first magnetic field to reduce a descent speed of the elevator car under a free-fall condition, thereby preventing a free-fall of the elevator car.

### TECHNICAL FIELD

This disclosure generally relates to the field of safety of elevator systems. More particularly, this disclosure relates to the free-fall protection assembly for the elevator system and a method thereof.

### BACKGROUND

Free-fall refers to the uncontrolled descent of any object. Similarly, free-fall of an elevator car of an elevator system refers to the uncontrolled fall of the elevator ground under the influence of gravity. This resulted due to a sudden failure of lift cables or braking system coupled to the elevator car.

Free-fall from an elevator not only causes damage to the elevator but is also disastrous and life-threatening to passengers inside the elevator. To overcome this situation and prevent such catastrophic incidents, elevator cars are equipped with numerous safety mechanisms such as braking systems, a governor mechanism to regulate the speed of the elevator car, and trigger safety brakes if a free-fall condition is detected. However, present solutions require a large number of components and high installation costs, the lack of maintenance of which may result in the free-fall of the elevator car.

Therefore, there is a requirement for a solution to enhance the safety of the elevator systems by preventing the free-fall of the elevator car.

### SUMMARY

In an embodiment, a free-fall prevention assembly for an elevator car is disclosed. In an embodiment, the free-fall prevention assembly may include a magnetic element positioned underneath the elevator car, to generate a first magnetic field. The free-fall prevention assembly may include a copper bucket positioned in an elevator pit to generate a second magnetic field in response to an eddy current induced therein. It should be noted that the eddy current is induced in response to a passage of the first magnetic field through the copper bucket as the magnetic element of the elevator car moves relative to the copper bucket in the elevator pit. Further, the second magnetic field repels the first magnetic field to reduce a descent speed of the elevator car under a free-fall condition, thereby preventing a free-fall of the elevator car.

In another embodiment, an elevator assembly is disclosed. The elevator assembly may include an elevator car, and a magnetic element positioned underneath the elevator car, to generate a first magnetic field. The elevator assembly may also include a copper bucket positioned in an elevator pit to generate a second magnetic field in response to an eddy current induced therein. It should be noted that the eddy current is induced in response to a passage of the first magnetic field through the copper bucket as the magnetic element of the elevator car moves relative to the copper bucket in the elevator pit. Further, the second magnetic field repels the first magnetic field to reduce a descent speed of the elevator car under a free-fall condition, thereby preventing a free-fall of the elevator car.

In yet another embodiment, a method of preventing the free-fall of an elevator car is disclosed. In an embodiment, the method may include generating a first magnetic field by a magnetic element positioned underneath the elevator car. The method may further include generating a second magnetic field by a copper bucket positioned in an elevator pit. It should be noted that the second magnetic field is generated in response to an eddy current in the copper bucket. It should be noted that the eddy current is induced in response to a passage of the first magnetic field through the copper bucket as the magnetic element of the elevator car moves relative to the copper bucket in the elevator pit. The method may include reducing a descent speed of the elevator car to prevent the free-fall of the elevator car, based on a repulsion of the first magnetic field by the second magnetic field.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a schematic of an elevator assembly, in accordance with an embodiment of the present disclosure.

FIG. 2 illustrates a schematic of a free-fall prevention assembly for an elevator car, in accordance with an embodiment of the present disclosure.

FIG. 3 a magnetic field diagram generated in the free-fall prevention assembly in accordance with an embodiment of the present disclosure.

FIG. 4 illustrates a system diagram for a free-fall prevention assembly, in accordance with an embodiment of the present disclosure.

FIG. 5 illustrates an exemplary process flow diagram for modifying the first magnetic field and the second magnetic field, in accordance with an embodiment of the present disclosure.

FIG. 6 illustrates a process flowchart of the functioning of a free-fall prevention assembly is illustrated, in accordance with an embodiment of the present disclosure.

### DETAILED DESCRIPTION

The foregoing description has broadly outlined the features and technical advantages of the present disclosure in order that the detailed description of the disclosure that follows may be better understood. Additional features and advantages of the disclosure will be described hereinafter which forms the subject of the claims of the disclosure. It should be appreciated by those skilled in the art that the conception and specific embodiments disclosed may be readily utilized as a basis for modifying other devices, systems, assemblies, and mechanisms for carrying out the same purposes of the present disclosure. It should also be realized by those skilled in the art that such equivalent constructions do not depart from the scope of the disclosure as outlined in the appended claims. The novel features are believed to be characteristics of the disclosure, to its device or system, together with further objects and advantages that will be better understood from the following description when considered in connection with the accompanying figures. It is to be expressly understood, however, that each of the figures is provided for the purpose of illustration and description only and is not intended as a definition of the limits of the present disclosure.

The terms “including”, “comprises”, “comprising”, “comprising of” or any other variations thereof, are intended to cover a non-exclusive inclusion, such that a system or a device that comprises a list of components or steps does not include only those components or steps but may include other components or steps not expressly listed or inherent to such setup or device. In other words, one or more elements in a system or apparatus proceeded by “comprises . . . a” does not, without more constraints, preclude the existence of other elements or additional elements in the system or apparatus.

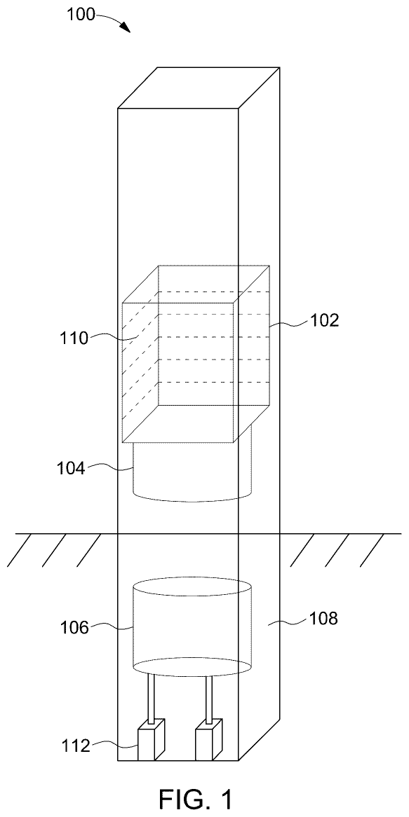

Reference will now be made to the exemplary embodiments of the disclosure, as illustrated in the accompanying drawings. Wherever possible, the same numerals have been used to refer to the same or like parts. The following paragraphs describe the present disclosure with reference to FIGS. 1-5. It is to be noted that the system may be employed in any elevator car including but not limited to a passenger elevator car, a utility elevator car, a commercial elevator car, and any other type of elevator car with an exhaust system.

At present, elevator cars are equipped with numerous safety mechanisms to prevent such catastrophic incidents as falling freely, as explained earlier. The present technology for preventing elevator cars from free-fall includes multiple braking systems that engage automatically in the event of a cable failure. In another example, the elevator cars may include governor mechanisms that regulate the speed of the elevator cars and trigger one or more safety protocols if an overspeed is detected. Alternatively, an elevator pit may include buffer systems to cushion the fall should all other safety mechanisms fail. However, the present systems need a large number of components and high installation costs. A lack of maintenance represents a high-risk potential, which can compromise their reliability, and also a huge space for the components is required. Despite advancements in elevator free-fall prevention systems, conventional free-fall prevention systems still fall short in several areas, it requires additional system installments, manual effort, or other tools and technologies to prevent the elevator from falling freely on the ground.

To this end, a free-fall prevention assembly for an elevator car in a free-fall condition is disclosed. The free-fall prevention assembly may be integrated with elevator cars such as but not limited to passenger elevators, traction elevators, freight elevators, hydraulic elevators, dumbwaiters, elevator motors, residential elevators, roped hydraulic elevators machine room (MRL) elevators and the like, to reduce speed during a free-fall.

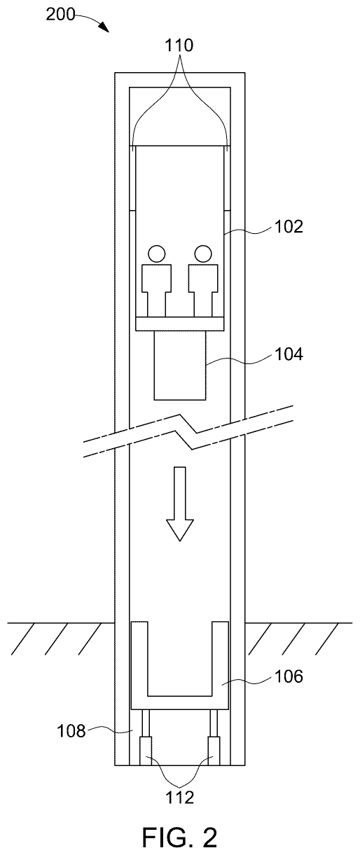

Referring now to FIG. 1, a schematic 100 of an elevator assembly is illustrated, in accordance with an embodiment of the present disclosure. Referring to FIG. 2, a schematic 200 of a free-fall prevention assembly for an elevator car 102, is illustrated, in accordance with some embodiments of the present disclosure. The free-fall prevention assembly may include a magnetic element 104 positioned underneath an elevator car 102. It should be noted that the magnetic element 104 is any one of but not limited to an electromagnet, a permanent magnet, Samarium-Cobalt magnets, Alnico Magnets, Bar magnets, Neodymium magnets, and the like.

The free-fall prevention assembly may further include a plurality of copper linings 110 adjoined externally to the elevator car 102, around the walls of the elevator car 102 except the door of the elevator car 102. The plurality of copper linings 110 may be fastened to the walls of the elevator car 102 using any fastening methods commonly known in the art.

In an embodiment, the elevator assembly may include an elevator pit 108. The free-fall prevention assembly may include a copper bucket 106 positioned in the elevator pit 108. The copper bucket 106 may be designed in a shape, or the dimensions of the copper bucket 106 may be based on such as, but not limited to a container, a bucket, a cylinder, and the like. The copper bucket 106 may be shaped corresponding to the shape of the magnetic element 104. Moreover, the copper bucket 106 may also be designed based on at least one of the second magnetic field induced in response to the magnetic field generated by the magnetic element 104, the carrying capacity of the elevator car 102, and the depth of the elevator pit 108.

The free-fall prevention assembly may further include a plurality of elevator buffers 112. The plurality of elevator buffers 112 are safety devices and may include such as hydraulic buffers (hydraulic shock absorbers), and mechanical buffers (coil springs), installed at the bottom of the elevator pit 108. Further, the plurality of elevator buffers may be configured to absorb and dissipate the kinetic energy of the elevator car 102. In other words, prevent the elevator car 102 from hitting the elevator pit 108 with too much force, specifically during free-fall.

In an embodiment, the copper bucket 106 may be coupled to the plurality of elevator buffers 112. For example, if the plurality of elevator buffers 112 may include a hydraulic buffer in which a cylinder may be coupled to the elevator pit 108, and a piston extending from the cylinder may be coupled to the copper bucket 106. As such, the copper bucket 106 may be rested on the plurality of elevator buffers 112, and collectively, may be configured to prevent the elevator car 102 from hitting the elevator pit 108 with too much force, specifically during free-fall. This is explained in detail, hereinafter.

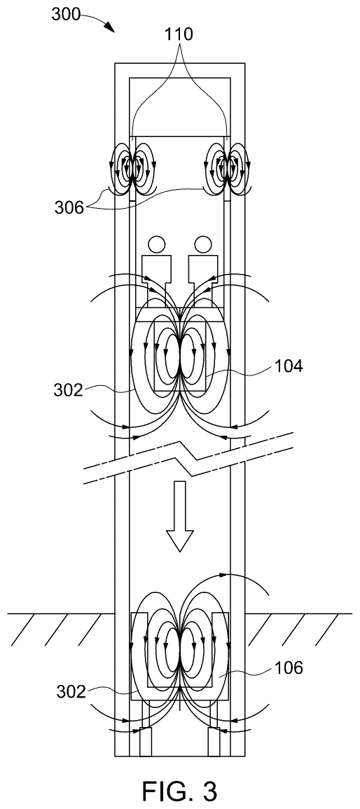

In an embodiment, the magnetic element 104 may be configured to generate a first magnetic field. During free-fall, as the elevator car 102 approaches the elevator pit 108, the first magnetic field may be configured to induce an equal and opposite magnetic field in the copper bucket 106 and the plurality of copper linings 110. The magnetic files induced in the copper bucket 106 and the plurality of copper linings 110 may be configured to repel the first magnetic field to reduce the speed of the elevator car 102 during free-fall. This is explained in detail, in conjunction with FIG. 3.

FIG. 3 illustrates a magnetic field diagram 300 generated in the free-fall prevention assembly, in accordance with an embodiment of the present disclosure. In an embodiment, the magnetic element 104 may be configured to generate a first magnetic field 302. It should be noted that in the case of the electromagnet, the magnetic element 104 is configured to generate the first magnetic field 302 in response to an electric current passing through. The electric current may be transmitted using a power circuit (not shown). As may be appreciated, the power circuit may be configured to controllably transmit electric current to the magnetic element 104. Hence, the first magnetic field 302 may be varied based on the electric current transmitted to the magnetic element 104. For example, to increase the first magnetic field 302, the electric current supply to the magnetic element 104 may be increased. In contrast, to decrease the first magnetic field 302, the electric current supply to the magnetic element 104 may be decreased.

During free-fall, the first magnetic field 302 is a time-varying magnetic field when the elevator car moves through the elevator shaft, relative to the copper bucket 106. The first magnetic field 302 produced by the magnetic element 104 may be configured to induce an eddy current within the copper bucket 106. As a result, an equal and opposite magnetic field in the copper bucket 106 may be generated. The interaction between the first magnetic field 302 and the copper bucket 106 leads to electromagnetic induction within the copper bucket 106, described by Faraday's Law of Induction:

$$ε = \frac{d {Φ}_{a}}{dt} \qquad ( 1 )$$

Where ε is the induced electromotive force (EMF) in the copper bucket 106, dΦₐ is the magnetic flux through a surface of the copper bucket dependent on the first magnetic field 302. As the elevator car 102 moves, the magnetic flux dΦₐ changes, inducing a time-varying EMF within the copper bucket 106. The induced EMF generates circulating eddy currents in the copper bucket 106, which, according to Lenz's Law, results in a second magnetic field 304 that opposes the first magnetic field 302. The second magnetic field 304 generates a resistive force, which is determined using Lorentz Force Law:

$$F = q \{ E + ( v \times B \} \qquad ( 2 )$$

q is the charge of the moving particles in the copper bucket 106, E is the electric field due to the induced EMF, and v is the velocity of the elevator car 102. This resistive force is configured to resist, or repel the force generated by the first magnetic field 302, and dampens the kinetic energy of the elevator car 102 to reduce descent speed of the elevator car 102 during the free-fall. Accordingly, the free-fall of the elevator car 102 may be prevented.

With continued reference to FIG. 3, and in addition to the second magnetic field 304, a third magnetic field 306 may be generated within the copper linings 110 due to the first magnetic field 302. It must be noted that the third magnetic field 306 may be generated similarly to the generation of the second magnetic field 304. The third magnetic field 306 may be generated along the direction of the free-fall within the elevator shaft. Hence, the third magnetic field 306 may also generate another resistive force, (similar to the resistive force generated by the second magnetic field 304) and may reduce the speed of the elevator car 102 during free-fall. Such combination of resistive forces contribute to the overall damping or kinetic energy dissipation of the elevator car 102 within the elevator system. Hence, kinetic energy dissipation may reduce the descent speed of the elevator car 102, and the elevator car 102 may be cushioned by the copper bucket 106 and the plurality of elevator buffers 112.

Scenarios in which the elevator car 102 coupled with an electromagnet as the magnetic element 104 may include passengers, the added weight of the passengers may also increase the descent speed of the elevator car 102 during free-fall. Accordingly, the electric current supplied to the magnetic element 104 may also be adjusted to induce a high eddy current within the copper bucket 106. As a result, the second magnetic field 304 may be increased, and the resistive force resulted due to the increased second magnetic field 304 may also increase, thereby providing an effective reduction in the descent speed of the elevator car 102 occupied with passenger. This is explained in detail, hereinafter.

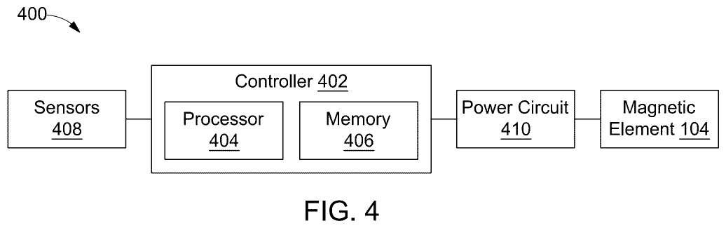

Now, referring to FIG. 4, a system diagram 400 for a free-fall prevention assembly is illustrated, in accordance with an embodiment of the present disclosure. In an embodiment, the system diagram for the free-fall prevention assembly for the elevator car 102 may include a controller 402. The controller 402 may include processor(s) 404, a memory 406, a sensor unit 408, and a power circuit 410.

In an embodiment, the controller 402 may include an Electronic Controller (ECU), a Body Control Module (BCM), or an externally installed processing unit known in the art, which may be constructed as a microprocessor including a processing unit formed of one or more microprocessors, microcomputers, single board computers, microcontrollers, digital signal processors, central processing units, graphics processing units, logic circuitries, and/or any devices that manipulate data received from various sensors installed in the elevator car 102. In an embodiment, the controller 402 may be configured to control and manage the functionalities of the elevator car 102 such as but not limited to receiving signals from the elevator car 102 and the sensor unit 408, sending signals that manage the different components of the elevator car 102, managing acceleration and deceleration of the elevator car 102, supplying electricity from the power source 412 to the components of elevator car 102 and the magnetic element 104, and the like.

In an embodiment, processor(s) 404 may include but are not limited to, microcontrollers, microprocessors, digital signal processors (DSPs), application-specific integrated circuits (ASICs), field-programmable gate arrays (FPGAs), system-on-chip (SoC) components, or any other suitable programmable logic devices. Examples of processor(s) 404 may include but are not limited to, an Intel® Itanium® or Itanium 2 processor(s), AMD® Opteron® or Athlon MP® processor(s), Motorola® lines of processors, Nvidia®, FortiSOC™ system on a chip processors or other future processors. The processor(s) 404 may include but are not limited to, the aforementioned processors, thereby enabling the controller 402 to process the functioning of the elevator car 102.

In an embodiment, the memory 406 may store a plurality of data, algorithms, and processor-executable instructions that, when executed by the processor(s) 404, cause the processor(s) 404 to implement various functionalities such as to run and control the elevator car 102 and sense a weight of the elevator car 102, and the like, as discussed earlier. In an embodiment, the memory 406 may be a non-volatile memory or a volatile memory. Examples of non-volatile memory may include but are not limited to, flash memory, Read Only Memory (ROM), a Programmable ROM (PROM), Erasable PROM (EPROM), and Electrically EPROM (EEPROM) memory. Further, examples of volatile memory may include but are not limited to, Dynamic Random Access Memory (DRAM), and Static Random-Access Memory (SRAM).

In an embodiment, the sensor unit 408 includes sensors such as but not limited to magnetic field sensors, velocity sensors, eddy current sensors, weight sensors, and the like. The magnetic field sensors may further include a Hall Effect sensor, positioned adjacent to the magnetic element 104 on the elevator car. The magnetic field sensor is configured to detect and generate a magnetic field sensor signal based on the strength and direction of the magnetic field generated by the magnet as the elevator car 102 moves under free-fall. The velocity sensor may include but is not limited to, an accelerometer, which may detect and generate a velocity or a speed sensor signal of the elevator car 102 during free-fall. Moreover, the eddy current sensor may be positioned in close proximity to the copper bucket 106. The eddy current sensor may be configured to determine the eddy current and generate a eddy current sensor signal within the copper bucket 106. Further, the weight sensors may include, but are not limited to, load cells positioned at a bottom of the elevator car 102. The weight sensors may be configured to determine and generate a weight sensor signal based on the overall weight of the elevator car 102.

The controller 402 may be communicably coupled to the sensor unit 408. Further, the sensor unit 408 may be configured to transmit the magnetic field sensor signal, the velocity or speed sensor signal, the weight sensor signal, and the eddy current sensor signal to the controller 402. Based on these sensor signals, the controller 402 may be configured to determine the magnetic field, speed, weight of the elevator car, and eddy currents generated within the free-fall prevention assembly.

The power circuit 410 may be connected to the magnetic element 104. The power circuit 410 may be configured to supply electric current to the magnetic element 104. The power circuit 410 may include a power source, and an electric current control circuit connecting the power source to the magnetic element 104.

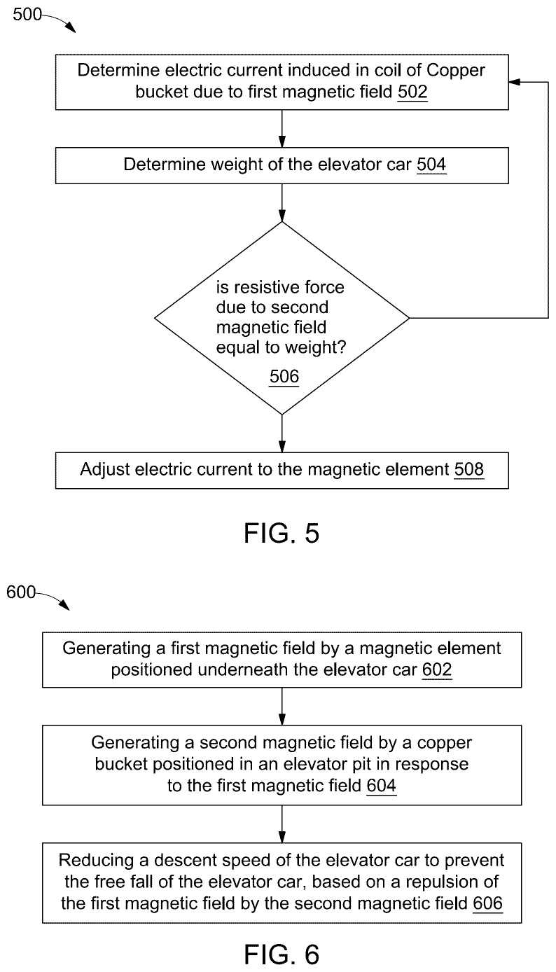

In an embodiment, the controller 402 may be communicably connected to the electric current control circuit through a feedback-based communication protocol that dynamically adjusts the electric current supplied to the magnetic element 104. The controller 402 may be configured to adjust the electric current based on the magnetic field, weight and speed of the elevator car, and eddy currents induced. Further, the controller 402 may generates a control signal, typically in the form of a Pulse Width Modulation (PWM) signal, to the electric current control circuit to regulate the current through the magnetic element 104. Accordingly, the first magnetic field 302 and the second magnetic field 304 may be modified. This is explained by way of an example, in conjunction with FIG. 5.

FIG. 5 illustrates an exemplary process flow diagram 500 for modifying the first magnetic field 302 and the second magnetic field 304, in accordance with an embodiment of the present disclosure. For example, when the elevator car 102 loaded with passengers may experience a free-fall, the controller 402 with the sensor unit 408, at step 502, may be configured to determine electric current, or eddy current induced in the copper bucket 106 due to the first magnetic field 302. Simultaneously, the controller 402 may be configured to determine the first magnetic field 302 with the sensor unit 408.

At step 504, controller 402 with the sensor unit 408 may be configured to determine the weight of the elevator car 102. Further, at step 506, the controller 402 may be configured to determine if the resistive force (refer to FIG. 3 and determined using equation 2) may be sufficient to repel, or equal to the overall weight of the elevator car 102. The overall weight herein may include the weight of the elevator car 102 and the total weight of the passengers included therein. If the resistive force is equal, or sufficient enough to repel the overall weight of the elevator car 102, the method may revert to step 502.

In contrast, if the resistive force is not equal to repel the overall weight of the elevator car 102, at step 508, the controller 402 may be configured to adjust via the electric current control circuit of the power circuit 410, the electric current supply to the magnetic element 104. As a result, the first magnetic field 302 generated by the magnetic element 104 may be modified, and hence, the second magnetic field 304 may be modified. As a result, the resistive force generated after the change in the second magnetic field 304 may be substantial enough to repel the weight of the elevator car 102 during free-fall.

Referring now to FIG. 6, a process flowchart 600 of the functioning of a free-fall prevention assembly is illustrated, in accordance with an embodiment of the present disclosure. At step 602, a first magnetic field 302 may be generated by the magnetic element 104, positioned underneath the elevator car 102. Subsequentially, at step 604, the second magnetic field 304 is generated within the copper bucket 106, due to the eddy current generated by the varying first magnetic field passing through the copper bucket 106 positioned in the elevator pit 108. Further, at step 606, the second magnetic field 304 may be configured to repel the first magnetic field 302 to reduce the descent speed of the elevator car 102 and prevent free-fall of the elevator car 102. To elaborate, the second magnetic field 304 may generate a repulsive force, to repel a force generated by the first magnetic field 302. This is explained in detail, in conjunction with FIGS. 1-5.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds truth for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A free-fall prevention assembly for an elevator car, comprising:
a magnetic element positioned underneath the elevator car, to generate a first magnetic field; and
a copper bucket positioned in an elevator pit to generate a second magnetic field in response to an eddy current induced therein, wherein the eddy current is induced in response to a passage of the first magnetic field through the copper bucket as the magnetic element of the elevator car moves relative to the copper bucket in the elevator pit,
wherein the second magnetic field repels the first magnetic field to reduce a descent speed of the elevator car under a free-fall condition, thereby preventing a free-fall of the elevator car.

2. The free-fall prevention assembly of claim 1, further comprises:
a plurality of copper linings adjoined externally to the elevator car, wherein the plurality of copper linings is configured to:
generate a third magnetic field based on response to the passage of the first magnetic field therethrough.

3. The free-fall prevention assembly of claim 1, wherein the magnetic element is any one of the:
an electromagnet configured to generate the first magnetic field in response to an electric current passing therethrough, or
a permanent magnet.

4. The free-fall prevention assembly of claim 3, further comprises:
a sensor unit communicably coupled to the elevator car and the copper bucket, the sensor unit configured to:
sense the weight of the elevator car; and
sense the eddy current induced in the copper bucket; and
a controller communicably coupled to the sensor unit, wherein the controller is configured to adjust the electric current to the electromagnet based on the eddy current induced in the copper bucket, to modify the first magnetic field against the second magnetic field generated due to the eddy current.

5. The free-fall prevention assembly of claim 1, wherein dimensions of the copper bucket are designed based on at least one of the:
the second magnetic field to be generated;
a carrying capacity of the elevator car; and
a depth of the elevator pit.

6. An elevator assembly, comprising:
an elevator car;
a magnetic element positioned underneath the elevator car, to generate a first magnetic field; and
a copper bucket positioned in an elevator pit to generate a second magnetic field in response to an eddy current induced therein, wherein the eddy current is induced in response to a passage of the first magnetic field through the copper bucket as the magnetic element of the elevator car moves relative to the copper bucket in the elevator pit,
wherein the second magnetic field repels the first magnetic field to reduce a descent speed of the elevator car under a free-fall condition, thereby preventing a free-fall of the elevator car.

7. The elevator assembly of claim 6, further comprises:
a plurality of copper linings adjoined externally to the elevator car, wherein the plurality of copper linings is configured to:
generate a third magnetic field based on response to the passage of the first magnetic field therethrough.

8. The elevator assembly of claim 6, wherein the magnetic element is any one of the:
an electromagnet configured to generate the first magnetic field in response to an electric current passing therethrough, or
a permanent magnet.

9. The elevator assembly of claim 8, further comprises:
a sensor unit communicably coupled to the elevator car and the copper bucket; the sensor unit configured to:
sense a weight of the elevator car; and
sense the eddy current induced in the copper bucket; and
a controller communicably coupled to the sensor unit, wherein the controller is configured to adjust the electric current to the electromagnet based on the eddy current induced in the copper bucket, to modify the first magnetic field against the second magnetic field generated due to the eddy current.

10. The elevator assembly of claim 6, wherein dimensions of the copper bucket are designed based on at least one of the:
the second magnetic field to be generated;
a carrying capacity of the elevator car; and
a depth of the elevator pit.

11. A method of preventing free-fall of an elevator car, the method comprising:
generating, by a magnetic element positioned underneath the elevator car, a first magnetic field;
generating, by a copper bucket positioned in an elevator pit, a second magnetic field, wherein the second magnetic field is generated in response to an eddy current in the copper bucket, wherein the eddy current is induced in response to a passage of the first magnetic field through the copper bucket as the magnetic element of the elevator car moves relative to the copper bucket in the elevator pit; and
reducing a descent speed of the elevator car to prevent the free-fall of the elevator car, based on a repulsion of the first magnetic field by the second magnetic field.

12. The method of claim 11, further comprises:
generating, by a plurality of copper linings adjoined externally to the elevator car, a third magnetic field based in response to the passage of the first magnetic field through the copper linings.

13. The method of claim 11, wherein the magnetic element is any one of:
an electromagnet configured to generate the first magnetic field in response to an electric current passing therethrough, or
a permanent magnet.

14. The method of claim 13, further comprises:
sensing, by a sensor unit, communicably coupled to the elevator car and the copper bucket, a weight of the elevator car and the eddy current induced in the copper bucket; and
adjusting, by a controller communicably coupled to the sensor unit, the electric current to the electromagnet based on the eddy current induced in the copper bucket, to modify the first magnetic field against the second magnetic field generated due to the eddy current.
